(19) United States
(12) Patent Application Publication
(10) Pub. No.: US 2004/0019503 A1
(43) Pub. Date: Jan. 29, 2004

(54) Modular home medical service terminal

(75) Inventor: Marc Berenguer, Revel (FR)

Correspondence Address: COHEN, PONTANI, LIEBERMAN & PAVANE, Suite 1210, 551 Fifth Avenue, New York, NY, 10176, US

(73) Assignee: France Telecom, Paris (FR)

(21) Appl. No.: 10/396,885

(22) Filed: Mar. 25, 2003

Related U.S. Application Data
(63) Continuation of application No. PCT/FR01/02915, filed on Sep. 20, 2001.

(30) Foreign Application Priority Data
Sep. 25, 2000 (FR) 00/12179

(51) Int. Cl. G06F 17/60

(52) U.S. Cl. 705/2

(57) ABSTRACT

A modular home medical service terminal includes a basic module (100) installed in a patient's home and is equipped with a telephone link (1) for communicating with a remote home medical service center. The basic module (100) is able to accommodate at least one additional module (200, 300, 400) that provides at least one home medical service functionality and which can exchange information with the remote center via the telephone link (1).

### RELATED APPLICATIONS

This is a Continuation of International Application PCT/FR01/02915, filed on Sep. 20, 2001.

### FIELD OF THE INVENTION

The present invention concerns a modular home medical service terminal that can be advantageously applied in all fields involving home medical services, such as home support, nursing assistance at home, or home hospitalisation and, more generally, for enabling patients living in their normal way of life to benefit from medical services. This is particularly the case when a person has decided to stay at home or return there after having undergone medical intervention but needing to keep in contact with a medical or paramedical service. This need is generally temporary in terms of its frequency and duration.

### BACKGROUND OF THE INVENTION

The unpublished French patent application no. 00 03367 concerns a home medical tele-assistance system for a patient, said system including a patient station or terminal including a certain number of equipment items that make it possible to provide medical assistance functions at the home of the patient. This terminal is in communication with a nursing station or a remote (used interchangeably with “distant”) home medical service center located in a hospital or an independent medical service and able to receive information from the patient's terminal and to send instructions to the equipment items installed at the home of the patient.

However, the home medical service terminal known in the prior art has two drawbacks. Firstly, when a given terminal has many varied functionalities, it is rare that all its features are fully used, thus generating a high investment/service ratio. Secondly, if it is desired to adopt improvements made to the items of equipment installed at the patient's home, adaptation frequently requires cumbersome structural modifications and involves significant costs and “down time”.

### SUMMARY OF THE INVENTION

An object of the present invention is to provide a terminal which can be customized to the required home medical service functions and which could also be modified according to the needs of the service, all the above being provided conveniently, efficiently, and at a minimum cost.

This and other objects are attained in accordance with one aspect of the invention directed to a modular home medical service terminal comprising basic module adapted to be installed at a patient's home, a communication link adapted to link the basic module with a remote home medical service center, and at least one additional module adapted for providing at least one home medical service functionality and operationally coupled to the basic module for exchanging information with the remote center via the communication link.

The design of the terminal of the present invention is based on modularity which enables the basic module to be adapted to the required services by adding suitably selected additional modules.

Moreover, each additional module can be developed and modified, independently of the basic module, according to subsequent improvements made in the technology, thus providing the modular terminal of the invention with significant flexibility concerning adaptation.

To summarize, the modularity of the service terminal of the invention has the following advantages:

Adaptability of the functionalities of the terminal to conform with the required services,

Design of the additional modules independent of one another and of the basic module,

Incorporate technical modifications and improvements without adversely affecting the entire terminal,

Optimization of the functions to be used,

Maintaining the level of usage facilitated via the interchangeability of the modules,

Low cost of the terminal for the best possible service.

According to one embodiment of the modular terminal of the invention, said basic module is a tele-assistance module including means for receiving images and sound originating from said center via a telephone line, and means for transmitting to the distant center images and sound originating from the home of the patient via the telephone line.

In this minimum version of the terminal of the invention, the basic module provides at the least possible cost an exclusively visiophonic tele-assistance service enabling the doctor located at the distant center to verbally communicate with the patient and receive visual information concerning said patient and his environment. To this effect, said transmission means are constituted by a camera that can be remote-controlled from the distant center, and a microphone.

It is also possible to have a simplified and more commercial version of the basic module in which said receiving means are constituted by a television receiver. The availability of these functions is made possible due to the fact that almost all patients have a television set at home. The simplified tele-assistance basic module is then used as an interface between the telephone network and the television receiver, the reception of images and sound being made on the television set of the patient by means of a “peritel” connector which, as is well known, is a connector designed to connect a TV set to various peripherals, such as a video tape recorder and a decoder box. The module no longer only manages the transmission means as a real function, namely the image and sound pick-up.

A more advanced version of the terminal of the invention further comprises an additional tele-monitoring module connected to said tele-assistance module, said tele-monitoring module including means for controlling assistance devices and/or bio-medical sensor.

When equipped as above, the modular terminal of the invention enables nursing personnel of the distant center to monitor a patient at his/her home by managing the assistance devices or the bio-medical sensors or both. Of course, the type of equipment used is adapted to the pathology of the patient and shall be prescribed by the doctor. It is this doctor who shall also prescribe the programs for managing the devices and sensors.

The modular nature of the terminal of the invention can, generally speaking, be again more easily configured via the automatic identification of an element of the terminal from the element to which it is connected situated immediately upstream in the modular chain. This automatic identification is preferably effected continuously at any time and not merely on powering up of the upstream element. In other words, the element in question is powered up by simply connecting it to the upstream element, it then being automatically identified by the latter so as to install the resources required for functioning of the first element. However, it ought to be pointed out that in the case of elements communicating with the upstream element via a radio-frequency link, power is directly provided from a mains supply, automatic identification from the upstream element taking place next.

According to the invention, said assistance devices and/or said biomedical sensors also comprise continuous automatic identification means at the tele-monitoring module, and the tele-monitoring module also comprises continuous automatic identification means at the tele-assistance module by installing in the tele-assistance module functional resources required for the functioning of the tele-monitoring module.

Another particularly advantageous characteristic of the invention resides in the fact that the tele-monitoring module also comprises means for triggering alarms at the distant center. This arrangement enables the nursing personnel of the distant center to be alerted of cases of, for example, the malfunctioning of one of the controlled elements, namely device or sensor, or the variation of data with respect to a reference value or program.

Having regard to the importance of this alarm triggering function, the invention provides in particular that the tele-assistance module continuously controls the presence of a line available on the telephone link and that the transmission of alarms is overriding on the telephone link. In this respect, it is preferable that the telephone link has a line continuously available for the transmission of alarms at the distant center.

Finally, another advanced version of the terminal of the invention consists in that it comprises an additional tele-consultation module able to receive medical diagnostic tools and means to record data provided by said tools.

According to one embodiment, the tele-consultation module is connected to the tele-assistance module and comprises automatic identification means with the tele-assistance module with installing of functional resources required for the functioning of the tele-consultation module.

As a variant, the tele-consultation module is connected to the tele-monitoring module and comprises continuous automatic identification means with the tele-monitoring module with the installing in the tele-assistance module of functional resources required for the functioning of the tele-consultation module.

It should also be mentioned that, in accordance with an improvement made to the modular terminal of the invention, the tele-assistance module comprises means for assisting the nursing personnel at the home of the patient. In particular, said assistance means include a scanner head, an electronic messaging device and photo pick-up means.

### BRIEF DESCRIPTION OF THE DRAWING

FIG. 1, which is the only drawing, is a diagram of a home medical service modular terminal in accordance with the invention.

### DETAILED DESCRIPTION OF THE DRAWING

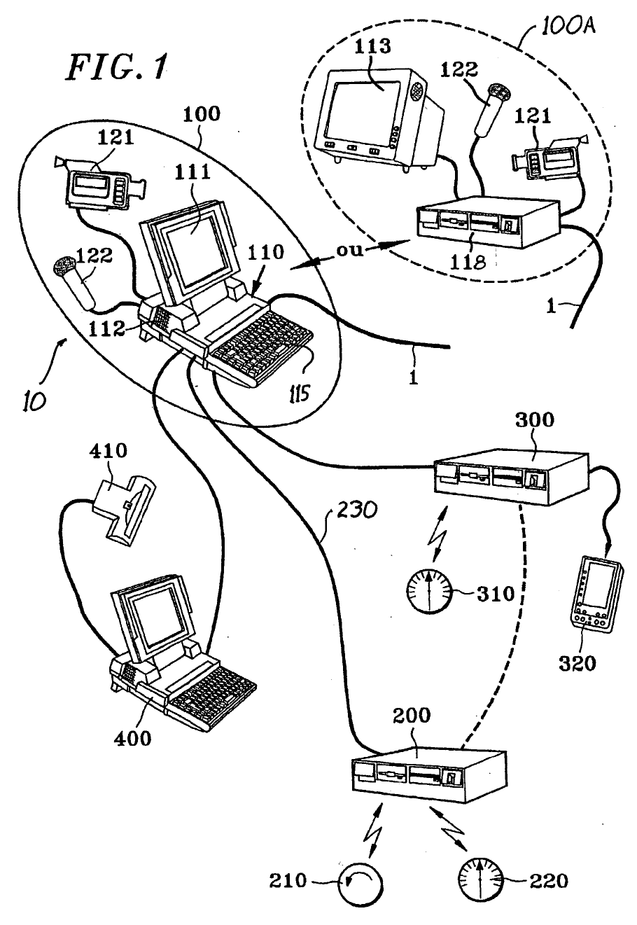

FIG. 1 shows a modular terminal 10 installed at the home of a patient wishing to benefit from the services of a home medical service, such as nursing care or any other medical assistance function. This terminal is connected to a distant center (not shown on FIG. 1) situated in, for example, a hospital environment and allowing a doctor to remote-monitor the patient at home for exchanging information or data with various equipment items that are part of the terminal.

More specifically, the modular terminal 10 of FIG. 1 includes a basic module 100 equipped with a telephone link 1 and which terminal, generally speaking, is able to accommodate at least one additional module for providing a home medical service functionality and for exchanging information with the distant center via the telephone link 1.

As will be described in detail below, the additional module can be a tele-monitoring module 200, a tele-consultation module 300 or even an assistance module 400 for nursing personnel at the home of the patient.

In the embodiment shown in FIG. 1, the basic module 100 is a tele-assistance module the main function of which is to offer an audio-visual communication service between the doctor situated at the distant center and the patient at home. To this effect, the tele-monitoring module 100 includes means for receiving images and sound originating from the distant center via the telephone link 1, these means being the monitor 111, keyboard 115 and a speaker 112 of a personal computer 110 connected to the telephone link 1. Computer 110 includes a central processing unit that comprises the memories and programs required for the functioning of the module 100. Similarly, the doctor receives images and sound originating from the home of the patient by means of transmission means which, in particular, are a remote-controlled camera 121 and a microphone 122.

It should be noted that the tele-assistance function is provided at a minimum cost due to use of a basic module 100 strictly intended for this function without the inclusion of other equipment used for other functions which would be not used in the invention.

Because of the fact that most patients have a television set at their home, it is possible to have a simpler version 100A of the tele-assistance module 100 (shown within a dotted line) in which said receiving means are constituted by a television receiver 113. The images and sound are received from the central processing unit 118 of the module 100A via the peritel socket of the television set. The central processing unit 110 only has to control the camera 121 and the microphone 122.

A certain number of improvements can be made to module 100, such as a signalling device, for example with keyboard 115, a call originating from the distant center, or even the presence of a radiofrequency device so as to initialize or accept a telephone communication originating from the distant center, and also to terminate it.

As shown on FIG. 1, the basic module 100 can operate with an additional module 200 known as a tele-monitoring module able to remote-monitor a patient by controlling medical devices 210 or biomedical sensors 220. This control is effected, for example, by a radiofrequency link with the tele-monitoring module 200, namely a wireless link.

Examples of medical devices 210 include oxygen concentrators for oxygen therapy and parenteral nutrition, and examples of biomedical sensors 220 are electrocardiogram recorders, spirometers, scales for heart-cases, tensimeters, etc.

The installation of the tele-monitoring module 200 is effected by simply connecting it to the basic module 100, such as with wire 230. Once the connection is made, the module 200 is automatically provided with power and at the same time is automatically self-identified at the basic module 100 with the installing of functional resources required for the functioning of the module 200. Similarly, the device 210 and the biomedical sensors 220 are automatically identified at the tele-monitoring module 200 on being powered up. This can be carried out automatically via connection to the tele-monitoring module 200 or when connected to the mains supply if the link with the module 200 is of the radiofrequency type. Generally speaking, automatic self-identification is effected via the transmission by module 200 of a specific identification message recognized by the identifying entity. Of course, any modification occurring on the terminal of FIG. 1 is transmitted to the distant center so that the latter is still informed of the current configuration of the terminal. These automatic identification and referencing actions are automatically carried out without the intervention of the operator who puts the terminal into service.

The loading of the program for managing the tele-monitoring module 200 is made either by the operator responsible for the installation with the aid of floppy disks or a CD-ROM prepared by authorised personnel, or by downloading from the distant center. Once the whole terminal is operational, the module 200 autonomously processes the data provided by the device 210 and sensors 220.

The management program is able to remote-modify the operating points of the assistance devices, remotely-read and download data to the distant center through the basic module, retrieve data, manage said data and compare it with reference value(s), manage alarms, the program verifying the state of the tele-monitoring module, the devices and sensors by video means, and in cases of malfunctioning is able to trigger an alarm to the distant center.

The alarm criteria are as follows: an excessive variation of a value with respect to a reference value, the detection of the malfunctioning of an assistance device or a sensor, a malfunctioning of the tele-monitoring module itself, in which case it is the basic module 100 which transmits the alarm to the distant center. Finally, to the extent that an alarm needs to be able to reach the center at all times, it is vital that the telephone link has available a channel continuously for transmitting alarms to the distant center, and moreover the alarm transmission is overriding on the telephone link. Also the programme continuously checks that a line is available and if this is not the case, an alarm is generated to the distant center.

Practically speaking, in the case of a link via the ISDN network for example, it is possible to use as a line reserved for the transmission of alarms the channel D, normally used for signals.

So as to enable the doctor at the distant center to eliminate doubts in alarm cases, an alarm is provided to automatically activate the means 121, 122 for transmitting images and sound originating from the home of the patient. The doctor then has access to all the information and data he needs to make a diagnosis.

As a means of security, the tele-monitoring module 200 comprises a buffer memory able to record the data after triggering of an alarm.

FIG. 1 also shows the presence in the terminal 10 of an additional tele-consultation module 300 for receiving medical diagnostic tools 310, such as a stethoscope or thermometer, and for recording data provided by these tools. By implementing various functionalities, the aim of this module 300 is to give a doctor the possibility of making a proper diagnosis. The list of functionalities is not exhaustive as it mainly depends on the pathology of the patient, the doctor and the availability of integrated tools able to provide a diagnostic function.

The link between the various diagnostic tools 310 and the tele-consultation module 300 is established by radio-frequency, except for the taking of photos function.

The tele-consultation module 300 can be installed according to several configurations in the modular terminal 10 of FIG. 1.

In a first configuration, the tele-consultation module 300 is connected to the tele-assistance module 100 and is automatically identified at the tele-assistance module with the installing in the tele-assistance module 100 of the functional resources required for the functioning of the tele-consultation module 300.

In a second configuration, the tele-consultation module 300 is connected to the tele-monitoring module 200 and is automatically identified at the tele-monitoring module with the placing in the tele-assistance module 100 of functional resources required for the functioning of the tele-consultation module 300.

Finally, in a third configuration, said tele-consultation module 300 is autonomous with the recording of the data provided by the medical diagnostic tool 310.

Having regard to the fact that this tele-consultation module 300 is not intended to necessarily remain continuously at the home of the patient but rather by being installed there immediately by the nursing personnel when asked for by the doctor, it is an advantage to ensure that the tele-consultation module 300 provided with diagnostic tools 310 is portable, for example contained in a case.

Several operating modes can be used for the tele-consultation module 300, namely:

the transmission of the data provided by the medical diagnostic tools 310 is carried out in direct read mode via the taking of images and transfer to the distant center,

the transmission of the data provided by the medical diagnostic tools 310 is carried out in indirect read mode by the taking of images, displaying on the tele-assistance module 100 and transfer to the distant center

the transmission of data is carried out in direct capturing of data via input and transfer to the distant center,

the transmission of data is carried out in indirect capturing of data via recording on a consultation terminal 320 for reading at the distant center. This consultation terminal is, for example, a portable personal assistance device.

Finally, FIG. 1 shows the presence of a module 400 for aiding the nursing personnel at the home of the patient. This module is able to modify the basic module 100 so as to integrate it with functions useful for the activity of the nursing personnel and, more particularly, for nurses who travel to the home of said patient.

These functions include electronic messaging for writing messages for other persons visiting the patient, namely home medical service personnel or the doctor treating said patient, or for writing a message to be transferred to the distant center or to another home service modular terminal. Electronic messaging is also able to read messages coming from the distant center and intended for nursing personnel visiting the patient, the doctor treating said patient or the patient him/herself.

Another function concerns the taking of photos. In this case, the nursing personnel located at the home of the patient disengage the remote-control of the camera 121, center the sight on the patient or any other object, record the photo and send it to the distant center. Such photos are sent to the remote center via module 400.

The module 400 is also used for the entering of written data to be sent to the distant center, either information to be entered on the file of the patient, or information (memo) to prepare the next home visit.

As indicated on FIG. 1, the assistance module 400 includes a scanner head 410 for copying documents (prescriptions, analysis results, etc) with display prior to being sent to the distant center. Similarly, the taking of photos can be controlled from the basic module 100 with display of the photo on the screen 111 before being transmitted to the distant center together with the patient file.

I claim:

1. A modular home medical service terminal comprising:
a basic module adapted to be installed at a patient's home
a communication link adapted to link said basic module with a remote home medical service center, and
at least one additional module adapted for providing at least one home medical service functionality and operationally coupled to said basic module for exchanging information with said remote center via said communication link.

2. The terminal according to claim 1, wherein said basic module comprises
a tele-assistance module including means for receiving images and sound originating from said center via the telephone link, and
means for transmitting to the remote center images and sound originating from the home of the patient via the telephone link.

3. The terminal according to claim 2, wherein said transmission means are constituted by a camera remote-controlled from the remote center, and a microphone.

4. The terminal according to claim 2, wherein said receiving means are constituted by a television receiver.

5. The terminal according to claim 2, wherein the image and sound receiving means comprise a device indicating a call originating from the remote center.

6. The terminal according to claim 2, further comprising a radiofrequency device able to initialise or accept a telephone communication originating from the remote center, and terminating it.

7. The terminal according to claim 2, further comprising an additional tele-monitoring module connected to said tele-assistance module, said tele-monitoring module including at least one of assistance control means and biomedical sensors.

8. The terminal according to claim 7, wherein a radiofrequency link is effected between said tele-monitoring module and the at least one of assistance control means and biomedical sensors.

9. The terminal according to claim 7, wherein the tele-monitoring module also comprises means for triggering alarms intended for the remote center.

10. The terminal according to claim 9, wherein the tele-assistance module continuously controls the presence of a line available on the telephone link.

11. The terminal according to claim 10, wherein the telephone link has a line continuously available for the transmission of alarms to the remote center.

12. The terminal according to claim 9, wherein the transmission of alarms is overriding on the telephone link.

13. The terminal according to claim 9, wherein an alarm automatically activates said means for transmitting images and sound originating from the patient's home.

14. The terminal according to claim 9, wherein the tele-assistance module comprises a buffer memory able to record data after triggering of an alarm.

15. The terminal according to claim 7, wherein said at least one of assistance control means and biomedical sensors comprise continuous automatic identification means at the tele-monitoring module.

16. The terminal according to claim 15, wherein the tele-monitoring module autonomously manages and continuously checks the condition of the assistance control means and biomedical sensors.

17. The terminal according to claim 7, wherein the tele-monitoring module comprises continuously automatic identification means at the tele-assistance module with the placing in the tele-assistance module of functional resources required for functioning of the tele-monitoring module.

18. The terminal according to claim 17, wherein the tele-assistance autonomously manages and continuously checks the condition of the tele-monitoring module.

19. The terminal according to claim 1, further comprising an additional tele-consultation module able to receive medical diagnostic tools and record data provided by said tools.

20. The terminal according to claim 19, wherein the tele-consultation module is connected to the tele-assistance module and comprises continuous automatic identification means at the tele-assistance module with the placing in the tele-assistance module of functional resources required for the functioning of the tele-consultation module.

21. The terminal according to claim 19, wherein the tele-consultation module is connected to the tele-monitoring module and comprises continuous automatic identification means at the tele-monitoring module with the placing in the tele-assistance module of functional resources required for the functioning of the tele-consultation module.

22. The terminal according to claim 19, wherein the transmission of data provided by the medical diagnostic tools is carried out in direct reading mode via the taking of images and transfer to the remote center.

23. The terminal according to claim 19, wherein the transmission of the data provided by the medical diagnostic tools is carried out in indirect reading mode via the taking of images and being displayed on the tele-assistance module before being transferred to the remote center.

24. The terminal according to claim 19, wherein the transmission of said data is effected in direct capturing of data mode by input and transfer to the remote center.

25. The terminal according to claim 19, wherein the transmission of said data is effected in indirect capturing of data mode by recording said data on a consultation terminal so as to be read at the remote center.

26. The terminal according to claim 25, wherein said tele-consultation module is autonomous with recording of the data provided by the medical diagnostic tools.

27. The terminal according to claim 18, wherein said of tele-consultation module fitted with the medical diagnostic tools is portable.

28. The terminal according to claim 2, wherein said tele-assistance module comprises an assistance module for aiding the nursing personnel at the home of the patient.

29. The terminal according to claim 28, wherein said assistance module includes a scanner head, electronic messaging, data input means and means for taking photos.
